(19) United States
(12) Patent Application Publication
(10) Pub. No.: US 2007/0236007 A1
(43) Pub. Date: Oct. 11, 2007

(54) Modified water separator

(76) Inventor: Hui-Huang Lin, Changhua County (TW)

Correspondence Address: EGBERT LAW OFFICES, 412 MAIN STREET, 7TH FLOOR, HOUSTON, TX, 77002, US

(21) Appl. No.: 11/400,818

(22) Filed: Apr. 10, 2006

(51) Int. Cl. F16L 41/00

(52) U.S. Cl. 285/133.4; 285/133.11

(57) ABSTRACT

The modified water separator includes a water inlet and two water outlets. A second water outlet must be connected to the water outlet components that have switches. The water inlet is placed in the same axial direction with a first water outlet, and a partition wall is placed between the water inlet and the first water outlet. The second water outlet is placed on the side between the water inlet and the first water outlet, and the water inlet is connected to the channel of the second water outlet by a central diversion tube. The second water outlet and the first water inlet are connected to the channel on the side by the central diversion tube. The water separator achieves the automatic switch, and its entire structure can be one piece.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a water separator, and more particularly to a structure that has no motional device.

### BACKGROUND OF THE INVENTION

A water separator is a pipe or hose component that controls the direction of water flow. Moreover, it has a single water inlet and double water outlets, which control the water flow from the first water outlet or second water outlet.

As for the conventional structure of the water separator, as shown in FIG. 1, the water separator disclosed in the figure is a external control type that is widely known. The water separator A1 is placed where the water inlet 13 of the water feeder 10 and the first water outlet 11 and second water outlet 12 meet. The water separator 10 includes an external control button 21 and a globe valve 22. The internal globe valve 22 uses control button 21 to control the direction of its internal globe valve 22 to achieve the purpose of switching the directions. This conventional water separator must be operated manually by the users; therefore, it has the disadvantage of inconvenience. Its structure must have control button 21 and globe valve 22, which creates problems, such as too many components that increase the cost of assembly.

In FIGS. 2 and 3, there is another water separator A2 with external control, and the water separator is placed where the water inlet 13B of the water feeder 10B meets with the first water outlet 11B and the second water outlet 12B. The water separator A2 includes an external control button 21B and an internal axial valve 22B. The axial valve has a vertical through hole 23 and an oblique through hole 24. When the control button 21B is placed in the first angle (as shown in FIG. 2), it makes the vertical through hole 23 connect to the water inlet 13B and the first water outlet 11B. When the control button 21B is placed in the second angle (as shown in FIG. 3), it makes the oblique through hole 24 connect to the water inlet 13B and the second water inlet 12B. This external water separator has the same disadvantages as the water separator mentioned above.

In FIG. 4, the water separator A3 mentioned in the figure is an internal control structure, and it is placed inside the water feeder 30. The separator A3 comprises a mobile valve stick 41 and a spring 42, and it does not need anyone to operate. When the first water outlet 31 of the water feeder 30 is closed and when the outlet of the second water outlet 32 is opened, its water pressure is larger than the spring force of the spring 42 and displaces the mobile valve stick 41 to make the water flow going to the second water outlet 32. On the other hand, when the first water outlet 31 is open (as shown in FIG. 4), the water flow is going in the direction of the first water outlet 31. The spring 42 pushes the mobile valve stick 41 backwards and closes the second water outlet 42. Because this internal controlled water separator A3 does not need manual operation, it is more convenient. Nevertheless, because it must coordinate with the mobile valve stick 41 and spring 42, it still has problems such as too many components that increase the cost of assembly. Therefore, the separator A3 still has room for improvement.

Thus, to overcome the aforementioned problems of the prior art, it would be an advancement in the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

1. The structure of the water separator of the present invention can be one piece, and it does not need a motion device, which saves the time spent on the assembly process, and greatly reduces the cost of production. The present invention is more practical than the prior art.

2. The flow switch function of the water separator of the present invention does not need to be operated manually, which is more convenient.

The features and the advantages of the present invention will be more readily understood upon a thoughtful deliberation of the following detailed description of a preferred embodiment of the present invention with reference to the accompanying drawings.

### BRIEF DESCRIPTION OF THE SEVERAL VIEWS OF THE DRAWINGS

FIG. 1 shows the longitudinal cross-sectional view of first conventional water separator structure.

FIG. 2 shows the another longitudinal cross-sectional view of the first flow of the second conventional structure.

FIG. 3 shows the another longitudinal cross-sectional view of the second flow of the second conventional structure.

FIG. 4 shows a partial elevation view and longitudinal cross-sectional view of the third conventional structure.

FIG. 5 shows the perspective view of the water separator of the present invention.

FIG. 6 shows a partial perspective and partial sectional view of the water separator of the present invention.

FIG. 7 shows the top plan view of the structure of the water separator of the present invention.

FIG. 8 shows a partial top plan view and a horizontal cross-sectional view of the structure of the water separator of the present invention.

FIG. 9 shows a longitudinal cross-sectional view of the operation of the flow of the water separator of the present invention.

FIG. 10 shows the second longitudinal cross-sectional view of the operation of the water separator of the present invention.

FIG. 11 shows the horizontal sectional view of the flow in FIG. 10.

FIG. 12 shows a partial elevation and partial longitudinal cross-sectional view of the application of the water separator of the present invention.

FIG. 13 shows a partial elevation and partial longitudinal cross-sectional view of the second application of the water separator of the present invention.

FIG. 14 shows a partial elevation and partial longitudinal cross-sectional view of the third application of the water separator of the present invention.

FIG. 15 shows a partial perspective and partial longitudinal cross-sectional view of the fourth application of the water separator of the present invention.

FIG. 16 shows a partial perspective and partial longitudinal cross-sectional view of the fifth application of the water separator of the present invention.

FIG. 17 shows a partial perspective and partial longitudinal cross-sectional view of the sixth application of the water separator of the present invention.

FIG. 18 shows a partial elevation and partial longitudinal cross-sectional view of the seventh application of the water separator of the present invention.

FIG. 19 shows a partial elevation and partial longitudinal cross-sectional view of the eighth application of the water separator of the present invention.

FIG. 20 shows a perspective view of another embodiment of the water separator of the present invention.

FIG. 21 shows the partial perspective and partial longitudinal cross-sectional view of the water separator disclosed in FIG. 20.

FIG. 22 shows the longitudinal cross-sectional view of the water separator disclosed in FIG. 20.

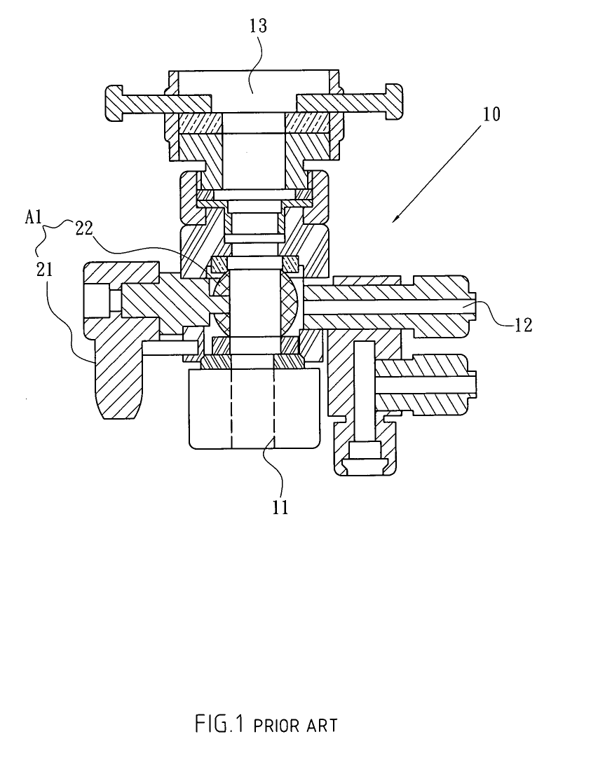

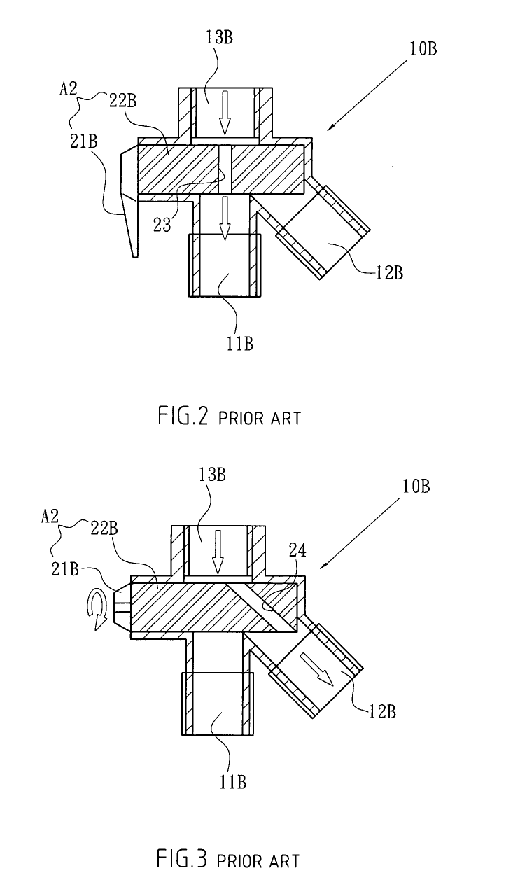

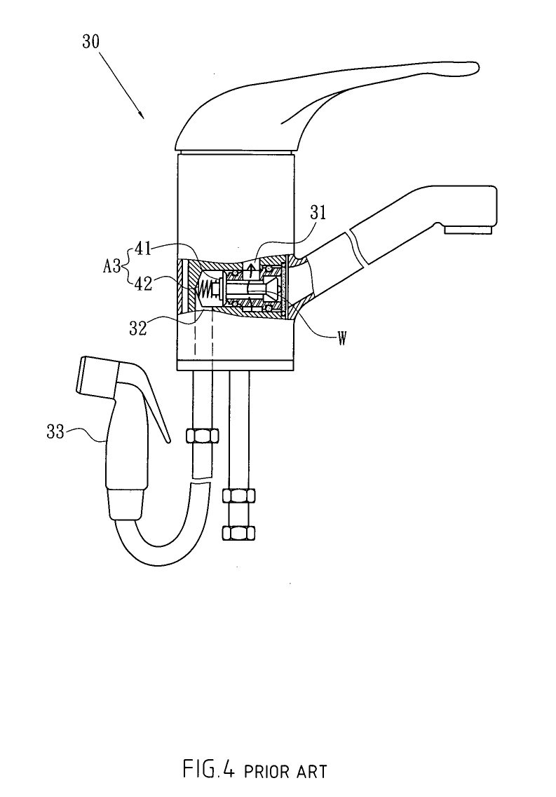

### DETAILED DESCRIPTION OF THE INVENTION

As shown in FIGS. 5-8, there is a preferred embodiment of a water separator 50.

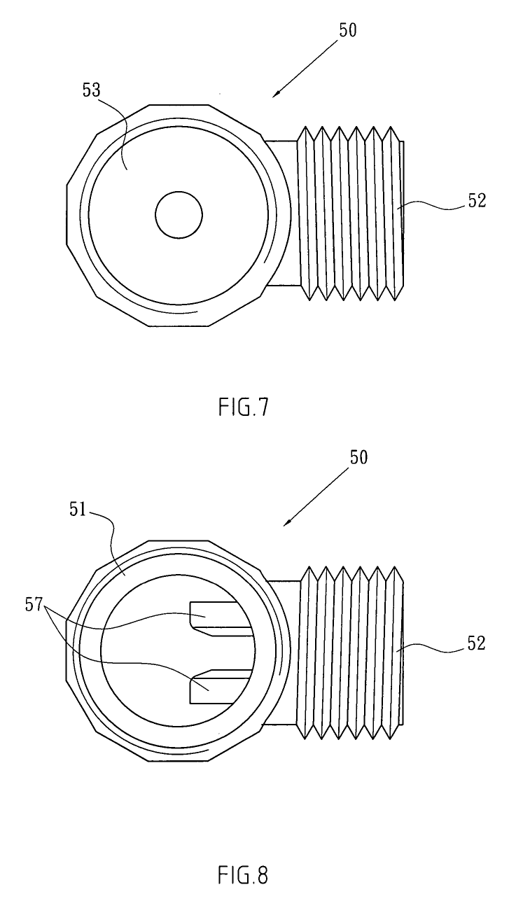

The present invention has a water inlet 53, a first water outlet 51 and a second water outlet 52. The second water outlet 52 must be connected to water outlet that has switches. The water inlet 53 is placed in the same axial direction with the first water outlet 51; however, a partition wall 54 is placed between the water inlet and the first water outlet 51. The second water outlet 52 is placed on the side between the water inlet 53 and the first water outlet 51. The water inlet 53 is connected to the channel of the second water outlet 52 by a central diversion tube 55, and the ratio of the flow channel section B1 of the central diversion tube 55 to the flow channel section B2 of the channel 56 of the second water outlet 52 is better between 1:15 to 1:18 (as shown in FIG. 7). By this arrangement, expected pressure is created when the water is coming out of central diversion tube 55. The second water outlet 52 and the first water inlet 51 are connected to the channel 56 on the side by the central diversion tube 55.

The entire water separator 50 can be a one-piece mode made of plastic material.

The water inlet 53 and the first water outlet 51 can be spiral types, wherein the spiral is internal.

The second water outlet 52 can be a spiral tube, wherein spiral is external.

The angles between the second water outlet 52 and the water inlet 53 and between the water inlet 53 and the first water outlet 51 are in 90° angles.

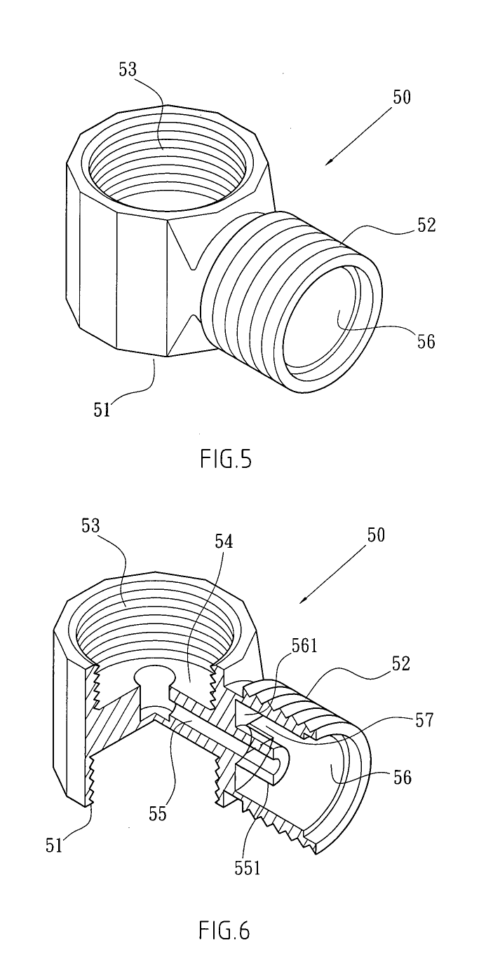

The water outlet 551 of the central diversion tube 55 mentioned above can be extended outwardly from the direction of the water outlet and from the internal wall 561 of the channel 56 of the second water outlet 52 to the tube with pre-determined length (as shown in FIGS. 6, 9 and 10).

Through the above structure and design, the operation of the present invention disclosed herein is explained.

As shown in FIG. 9, when the water outlet component of the second water outlet 52 is open, the water flow W1 from the water inlet 53 may create strong pressure W2 through the central diversion tube 55 mentioned above. The water flow is lead towards the outlet of the first water outlet, and at the same time, a sucking force W3 is created in the opposite direction to prevent water flow from coming out from the first water outlet 51.

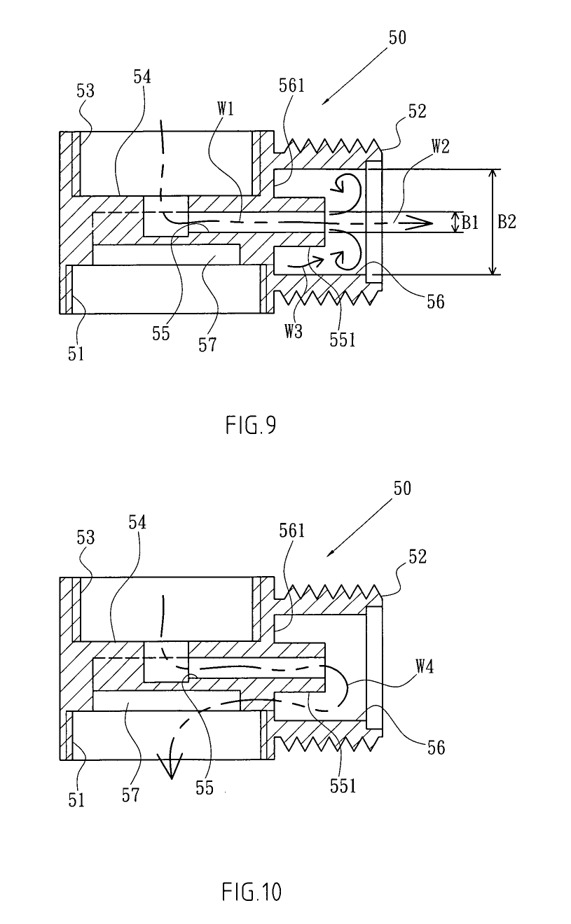

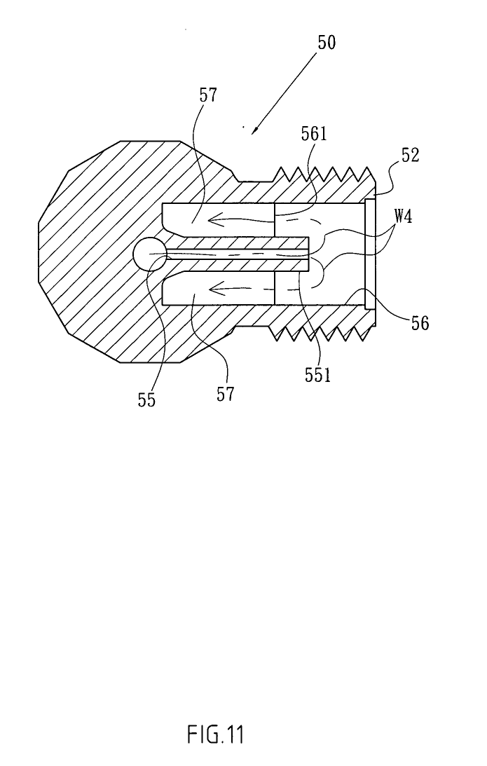

As shown in FIG. 10 11, when the outlet component of the second water outlet 52 is closed, and after the water flow W4 enter the first water outlet 51 through central diversion tube 55, it may lead the water flow to the first water outlet 51 from the channel 57 on the side.

The water separator 50 disclosed in the present invention can automatically switch the direction of the flow by the special design, and it is very different from the conventional structure.

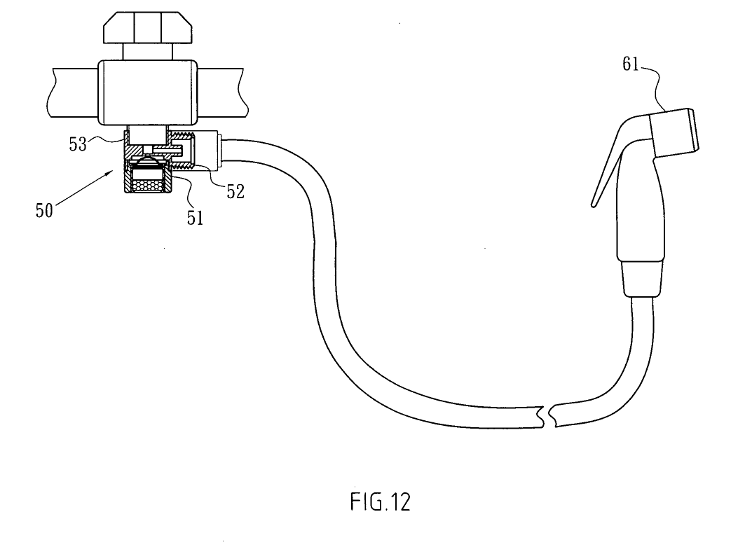

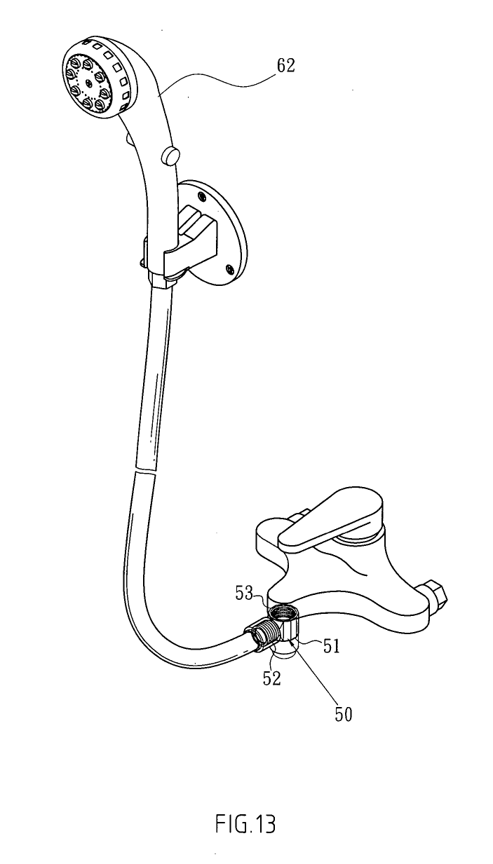

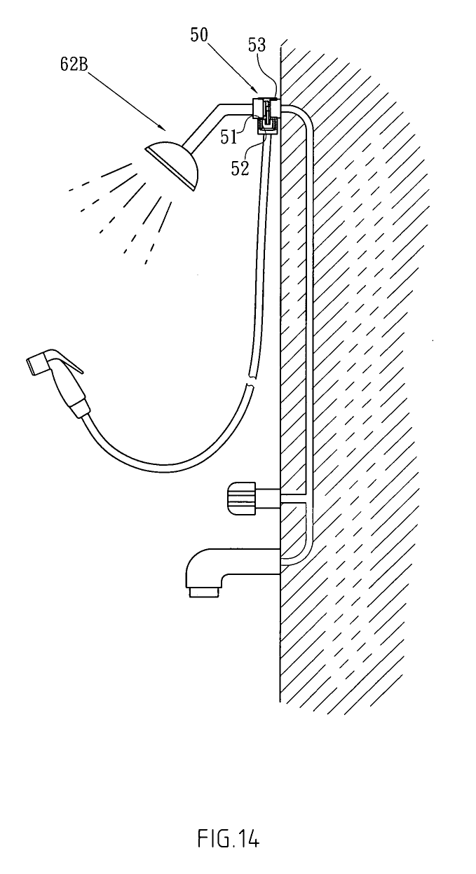

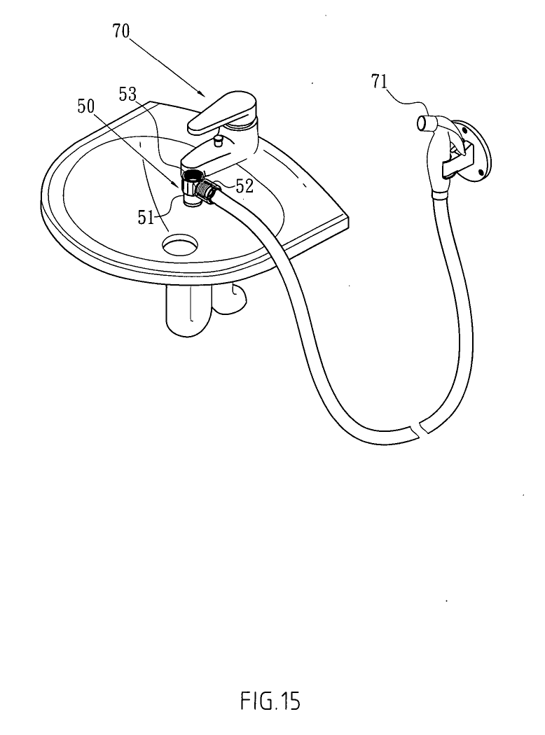

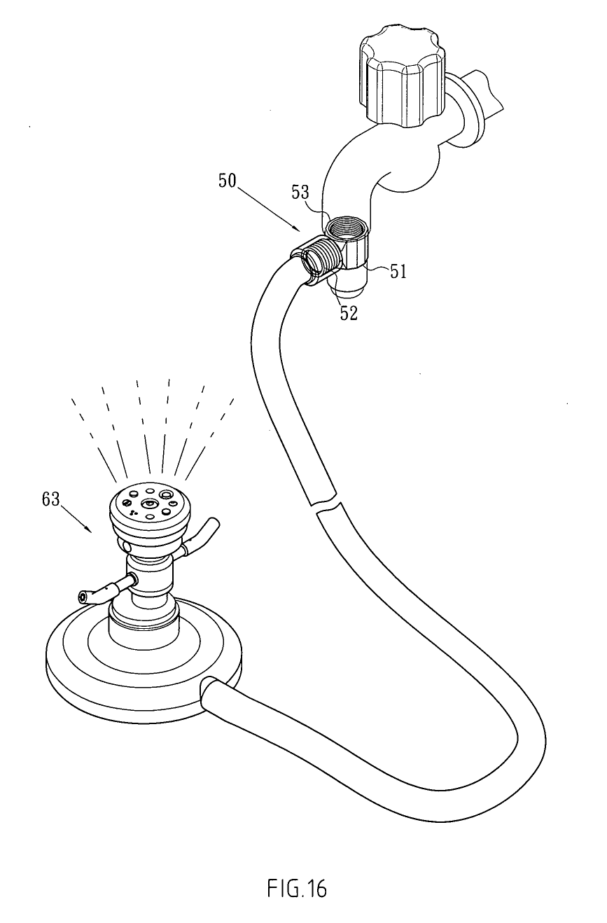

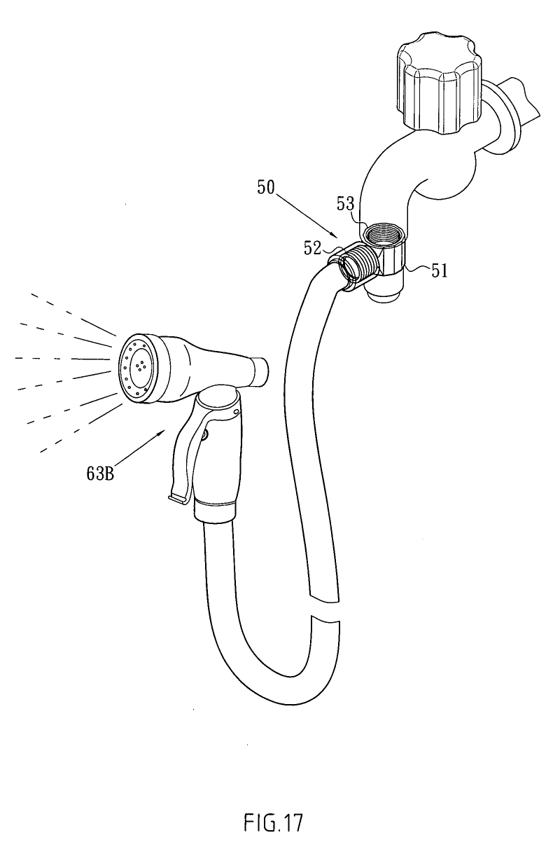

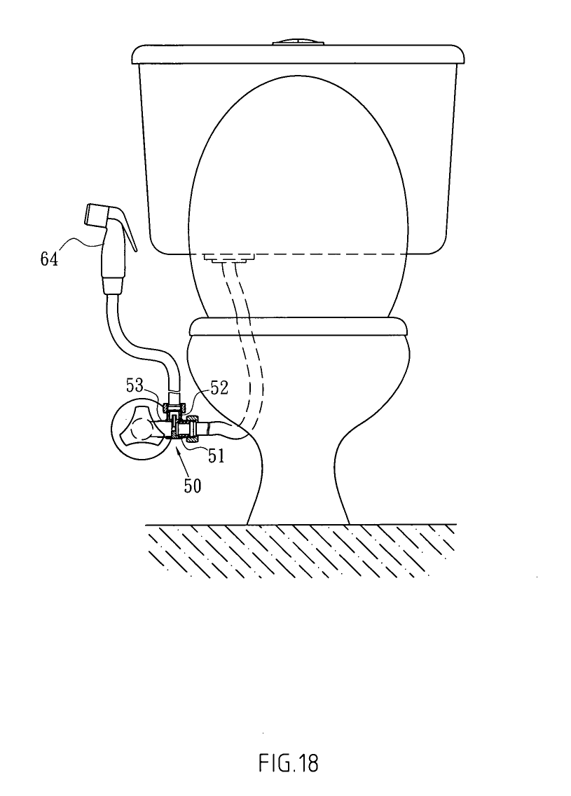

The application of the water separator can have many styles, as shown in FIGS. 12-18. The components of water outlet can form a nozzle 61 (as shown in FIG. 12), shower head 62 (as shown in FIG. 13), moveable shower head 62B (as shown in FIG. 14), nozzle 71 that can be added onto the faucet 70 over the sink (as shown in FIG. 15), sprinkler 63 (as shown in FIG. 16), sprayer 63B (as shown in FIG. 17) water supply channel, or a water outlet disclosed in FIG. 18 such as cleaning nozzle 64 by the toilet.

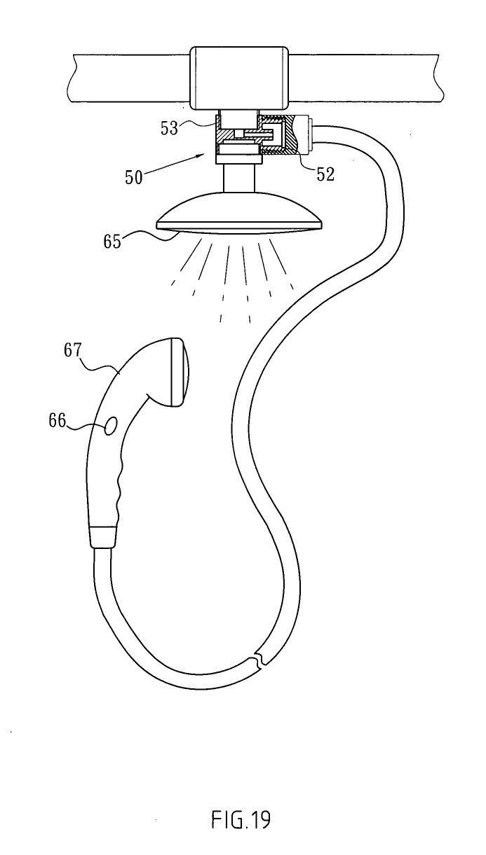

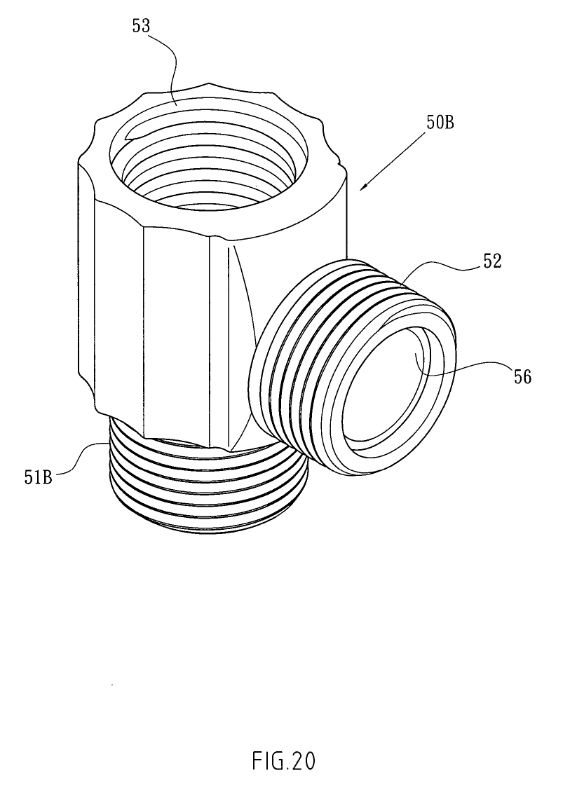

The water outlet components, disclosed in FIG. 19, such as shower head 67, have on and off switches for a shower nozzle 65, and this embodiment can use the design of the internal channel of the water separator 50. When the shower head 67 is off, the water can automatically come from the nozzle. On the other hand, when the shower head 67 is on, the water can come out from the shower head 67.

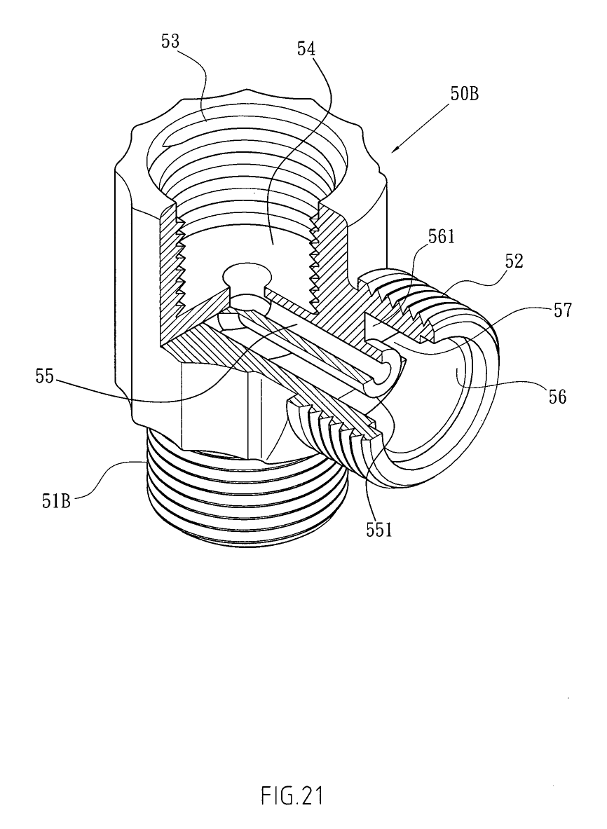

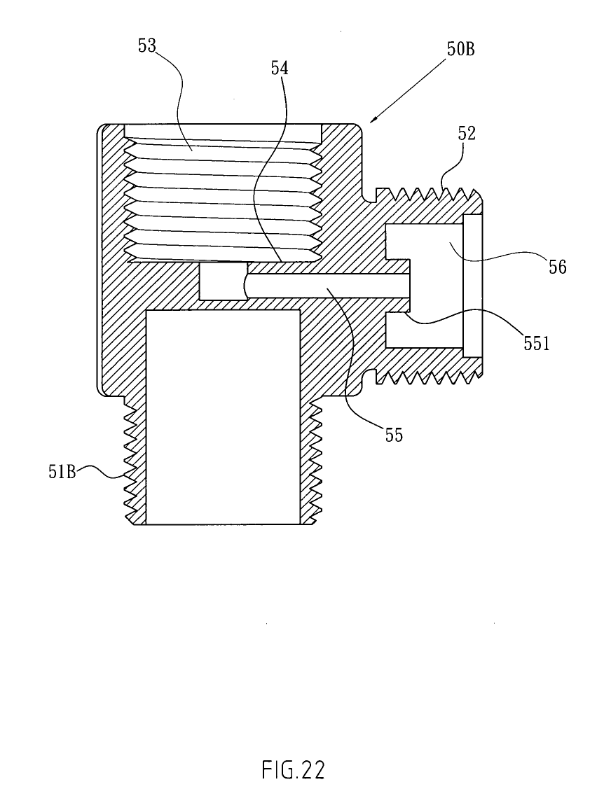

The water separator 50B shown in FIG. 20 is another embodiment, and the difference from the embodiment mentioned above is the first water outlet 51B being of an external spiral type. FIGS. 21 and 22 shows the partial perspective and sectional view and longitudinal cross-sectional view of the water separator 50B of the present invention.

Another embodiment of the water separator 50B has the first water outlet 51, the second water outlet 52, and the central diversion tube 55 as the water separator 50 mentioned above, therefore, it is not repeated here.

Although the invention has been explained in relation to its preferred embodiment, it is to be understood that many other possible modifications and variations can be made without departing from the spirit and scope of the invention as hereinafter claimed.

I claim:

1. A modified water separator, comprising:
a water inlet;
a first water outlet;
a second water outlet, wherein an axial direction of said water inlet is the same as said first water outlet;
a party wall placed between said water inlet and said first water outlet, said second water outlet being placed on a side between said water inlet and said first water outlet; and
a central diversion tube connecting said water inlet to a channel of said second water outlet, said second water outlet and said first water inlet being connected to said channel on a side by said central diversion tube.

2. The modified water separator defined in claim 1, wherein said second water outlet can be connected to another water outlet having switches.

3. The modified water separator defined in claim 2, wherein the other water outlet is formed of a shower head, nozzle, spray, sprinkler, or water supply.

4. The modified water separator defined in claim 1, wherein a ratio for a flow channel section of said central diversion tube and a flow channel section of said second water outlet ranges between 1:15 to 1:18.

5. The modified water separator defined in claim 1, being formed in one piece comprised of plastic material.

6. The modified water separator defined in claim 1, wherein said water inlet and said first water outlet have an internal spiral or an external spiral.

7. The modified water separator defined in claim 1, wherein said second water outlet is comprised of a spiral tube.

8. The modified water separator defined in claim 1, wherein angles between said second water outlet and said water inlet and between said water inlet and said first water outlet are 90° angles.

9. The modified water separator defined in claim 1, wherein a water outlet of said central diversion tube extend from an internal wall of said channel of said second water outlet outward to said central diversion tube with a pre-determined length.
